(19) United States
(12) Patent Application Publication
(10) Pub. No.: US 2022/0394534 A1
(43) Pub. Date: Dec. 8, 2022

(54) APPARATUS FOR RECEIVING A MEASUREMENT

(71) Applicant: NOKIA TECHNOLOGIES OY, Espoo (FI)

(72) Inventors: Benny VEJLGAARD, Gistrup (DK); Mark CUDAK, Rolling Meadows, IL (US); Frederick VOOK, Schaumburg, IL (US)

(73) Assignee: NOKIA TECHNOLOGIES OY, Espoo (FI)

(21) Appl. No.: 17/776,837

(22) PCT Filed: Nov. 6, 2020
(86) PCT No.: PCT/EP2020/081226

§ 371 Date: May 13, 2022

(30) Foreign Application Priority Data
Nov. 20, 2019 (FI) 20195994

(51) Int. Cl. H04W 24/10; H04B 17/318; H04W 16/28

(52) U.S. Cl. CPC H04W 24/10; H04B 17/318; H04W 16/28

(57) ABSTRACT

An apparatus and a system comprising at least one power integrator, method performed by an apparatus comprising at least one power integrator and computer program product for causing an apparatus comprising at least one power integrator to perform: receiving a measure of power level of at least one radio beam detected by an antenna array comprising a plurality of antenna elements, accumulating the received measure of power level over a period of time, determining a representative output signal corresponding to the accumulated measure of received power level and providing the representative output signal to a controller.

### TECHNICAL FIELD

The present application relates generally to an apparatus for receiving a measurement. More specifically, the present application relates to an apparatus for receiving a measurement relating to one or more radio beams.

### BACKGROUND

The amount of data increases constantly due to new ways of using user equipment such as streaming content. As a consequence, also users' expectations constantly rise in terms of speed of wireless connections and/or low power consumption of communication devices.

### SUMMARY

Various aspects of examples of the invention are set out in the claims. The scope of protection sought for various embodiments of the invention is set out by the independent claims. The examples and features, if any, described in this specification that do not fall under the scope of the independent claims are to be interpreted as examples useful for understanding various embodiments of the invention.

According to a first aspect of the invention, there is provided an apparatus comprising at least one power integrator, the apparatus comprising: means for receiving a measure of power level of at least one radio beam detected by an antenna array comprising a plurality of antenna elements, means for accumulating the received measure of power level over a period of time, means for determining a representative output signal corresponding to the accumulated measure of received power level and means for providing the representative output signal to a controller.

According to a second aspect of the invention, there is provided a method performed by an apparatus comprising at least one power integrator, the method comprising: receiving a measure of power level of at least one radio beam detected by an antenna array comprising a plurality of antenna elements, accumulating the received measure of power level over a period of time, determining a representative output signal corresponding to the accumulated measure of received power level and providing the representative output signal to a controller.

According to a third aspect of the invention, there is provided a computer program comprising instructions for causing an apparatus comprising at least one power integrator to perform at least the following: receiving a measure of power level of at least one radio beam detected by an antenna array comprising a plurality of antenna elements, accumulating the received measure of power level over a period of time, determining a representative output signal corresponding to the accumulated measure of received power level and providing the representative output signal to a controller.

According to a fourth aspect of the invention, there is provided an apparatus comprising at least one power integrator, the apparatus being configured to: receive a measure of power level of at least one radio beam detected by an antenna array comprising a plurality of antenna elements, accumulate the received measure of power level over a period of time, determine a representative output signal corresponding to the accumulated measure of received power level and provide the representative output signal to a controller.

According to a fifth aspect of the invention, there is provided a non-transitory computer readable medium comprising program instructions for causing an apparatus comprising at least one power integrator to perform at least the following: receiving a measure of power level of at least one radio beam detected by an antenna array comprising a plurality of antenna elements, accumulating the received measure of power level over a period of time, determining a representative output signal corresponding to the accumulated measure of received power level and providing the representative output signal to a controller.

According to a sixth aspect of the invention, there is provided a computer readable medium comprising program instructions for causing an apparatus comprising at least one power integrator to perform at least the following: receiving a measure of power level of at least one radio beam detected by an antenna array comprising a plurality of antenna elements, accumulating the received measure of power level over a period of time, determining a representative output signal corresponding to the accumulated measure of received power level and providing the representative output signal to a controller.

According to a seventh aspect of the invention, there is provided a system comprising at least one power integrator, the system comprising: means for receiving a measure of power level of at least one radio beam detected by an antenna array comprising a plurality of antenna elements, means for accumulating the received measure of power level over a period of time, means for determining a representative output signal corresponding to the accumulated measure of received power level and means for providing the representative output signal to the at least one controller.

According to an eight aspect of the invention, there is provided a system comprising at least one power integrator, the system being configured to: receive a measure of power level of at least one radio beam detected by an antenna array comprising a plurality of antenna elements, accumulate the received measure of power level over a period of time, determine a representative output signal corresponding to the accumulated measure of received power level and provide the representative output signal to a controller.

### BRIEF DESCRIPTION OF THE DRAWINGS

For a more complete understanding of example embodiments of the present invention, reference is now made to the following descriptions taken in connection with the accompanying drawings in which:

FIG. 1 shows a part of an exemplifying radio access network in which examples of disclosed embodiments may be applied;

FIG. 2 shows a block diagram of an example device in which examples of the disclosed embodiments may be applied;

FIG. 3 illustrates an example signal path according to an example embodiment of the invention;

FIG. 4 shows a block diagram of an example apparatus in which examples of the disclosed embodiments may be applied;

FIG. 5 shows a block diagram of an example apparatus in which examples of the disclosed embodiments may be applied;

FIG. 6 illustrates an example method according to an example embodiment of the invention;

FIG. 7 illustrates another example method according to an example embodiment of the invention;

FIG. 8 illustrates example measures of power level;

FIG. 9 illustrates a further example method according to an example embodiment of the invention;

FIG. 10 illustrates another example measures of power level.

### DETAILED DESCRIPTION OF THE DRAWINGS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Example embodiments relate to utilizing at least one power integrator and at least one phase shifter in a radio frequency (RF) front end module. The at least one power integrator enables the RF front end module to perform a full radio beam search or beam tracking without activating a whole RF chain. The at least one power integrator further enables operating the RF front end independent of the state of a terminal device. The at least one power integrator further enables operating the RF font end module such that the most suitable path towards a base station may be identified without demodulating a reference signal. Further, the at least one power integrator enables using beam sweeping for selecting an antenna element within a terminal device.

A plurality of phase shifters in an RF front end module enables measuring a plurality of radio beams concurrently. Further, a plurality of phase shifters together with at least one power integrator enables concurrent power measurements of a plurality of beams and concurrent power measurements of a plurality of antenna elements.

According to an example embodiment, an apparatus comprising at least one power integrator is configured to receive a measure of power level of at least one radio beam detected by an antenna array comprising a plurality of antenna elements, accumulate the received measure of power level over a period of time, determine a representative output signal corresponding to the accumulated measure of received power level, and provide the representative output signal to a controller. The apparatus may further comprise at least one phase shifter. The apparatus may be, for example, a radio frequency (RF) front-end module.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system may comprise also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communications system may comprise more than one (e/g)NodeB in which case the (e/g)NodeBs may also be configured to communicate with one another over links, wired or wireless, designed for the purpose. These links may be used not only for signalling purposes but also for routing data from one (e/g)NodeB to another. The (e/g)NodeB is a computing device configured to control the radio resources of communication system it is coupled to. The (e/g) NodeB may also be referred to as a base station, an access point, an access node, or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device refers, for example, to a wireless mobile communication device operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, navigation device, vehicle infotainment system, and multimedia device, or any combination thereof. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilise cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

A wireless device is a generic term that encompasses both the access node and the terminal device.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of content delivery use cases and related applications including, for example, video streaming, audio streaming, augmented reality, gaming, map data, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being integradable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low-latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilise services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of functions between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or node B (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway, maritime, and/or aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. In multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. A network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which may be installed within an operator's network may aggregate traffic from a large number of HNBs back to a core network.

As commonly known in connection with wireless communication systems, control or management information is transferred over a radio interface, e.g. between the terminal device 100 and the access node 104.

Wireless networks are configured to transmit data through radio beams. A radio beam provides an operating channel for transmitting data between a terminal device such as user equipment and a base station such as a gNodeB. A beam may be formed, for example, by a phased array antenna that comprises a plurality of antenna elements that are spatially arranged and electrically interconnected.

Beamforming is a spatial filtering technique that comprises directional signal transmission or reception. Directional transmission comprises directing radio energy through a radio channel towards a specific receiver. Directing radio energy may be performed by adjusting the phase and/or amplitude of transmitted signals such that the produced signal corresponds to a desired pattern. Directional reception comprises collecting signal energy from a specific transmitter. Collecting signal energy from a specific transmitter may be performed by changing a received signal in phase and amplitude such that the collected signal corresponds to a desired pattern.

Beamforming may support different kinds of beam patterns such as a quasi-omni pattern, a sector and a beam. Different patterns may be created by beam codebooks. A beam codebook comprises a set of analogue phase shift values and/or magnitude values to be applied to antenna elements in order to form an analogue beam. In practice, a beam codebook may comprise a matrix where a column specifies a beamforming weight vector and a pattern of direction. The codebooks provide the basis for beamforming operation in terminal devices and base stations.

Analog beamforming typically shapes a beam through a single radio frequency (RF) chain for the antenna elements and therefore it is possible transmit/receive in one direction at a time. An RF chain comprises a transceiver for transmitting and receiving radio signals and an RF front end module (RFFE) for enabling operation of a device with a specific radio frequency. An RF chain is configured to receive radio signals from at least one antenna and convert the received radio signals to baseband.

Beam sweeping comprises covering a spatial area with a set of beams transmitted and received according to predetermined intervals and directions. A beam comprises a unique synchronization signal block beam ID (SSB ID) and a physical beam index (PBI). A synchronization signal block (SSB) is configured to provide time and frequency synchronization and basic information such as how a terminal device can access the system, indication of the physical cell ID and where to find the remaining configurations.

A terminal device is configured to scan and monitor, based on a beam codebook, SSB reference signals of a plurality of possible beams and select the most suitable beam. The most suitable beam may be, for example, a beam with the strongest signal strength. Monitoring an SSB reference signal comprises measuring the signal strength of a beam detected within a predefined period. The terminal device is configured to identify and select a beam with the strongest signal strength.

Since a terminal device is configured to select the most suitable beam in different situations such as in switching from one antenna array to another, beam management and inter-cell mobility, significant power consumption is incurred. In addition, a terminal device is configured to scan SSB reference signals for a plurality of beams in different beam management operations such as beam acquisition, beam measurements for inter-cell handover, beam tracking and beam recovery. However, as decoding SSB codes is performed time multiplexed in a terminal device with analogue beamforming, the terminal device needs to scan each antenna element one at a time and thus wait for the next SSB period for scanning the next antenna element.

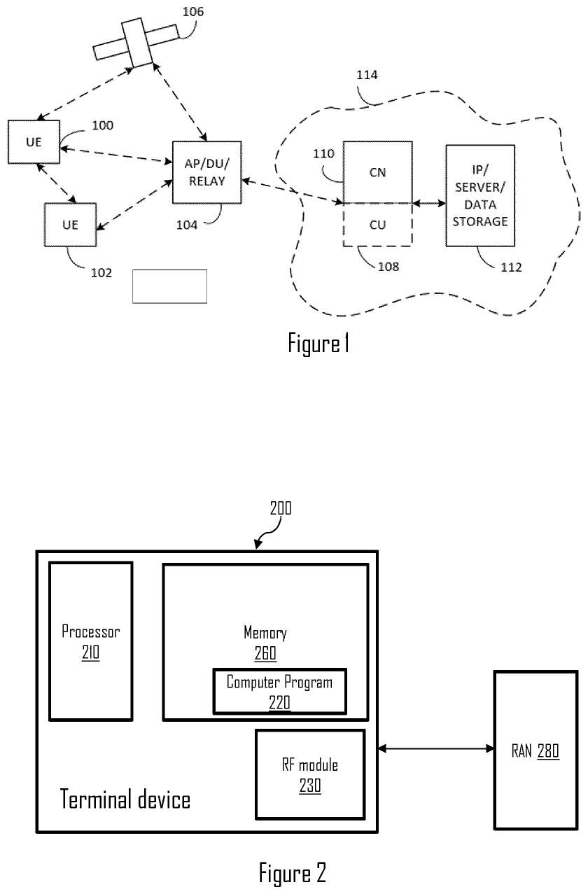

FIG. 2 is a block diagram depicting a terminal device 200 operating in accordance with an example embodiment of the invention. The terminal device 200 may be, for example, an electronic device such as a mobile computing device. The terminal device be a user equipment (UE). The terminal device 200 is configured to communicate with an access node such as a radio access network (RAN) 280. A RAN 280 may be a base station such as a gNodeB.

In the example of FIG. 2, the terminal device 200 comprises one or more control circuitry, such as at least one processor 210, and at least one memory 260, including one or more algorithms such as a computer program instructions 220 wherein the at least one memory 260 and the computer program instructions 220 are configured, with the at least one processor 210 to cause the terminal device 200 to carry out any of the example functionalities described below.

In the example of FIG. 2, the processor 210 is a central unit operatively connected to read from and write to the memory 260. The processor 210 may also be configured to receive control signals received via an input interface and/or the processor 210 may be configured to output control signals via an output interface. In an example embodiment the processor 210 may be configured to convert the received control signals into appropriate commands for controlling functionalities of the apparatus.

The memory 260 stores computer program instructions 220 which when loaded into the processor 210 control the operation of the terminal device 200 as explained below. In other examples, the terminal device 200 may comprise more than one memory 260 or different kinds of storage devices.

Computer program instructions 220 for enabling implementations of example embodiments of the invention or a part of such computer program instructions may be loaded onto the terminal device 200 by the manufacturer of the terminal device 200, by a user of the terminal device 200, or by the terminal device 200 itself based on a download program, or the instructions can be pushed to the terminal device 200 by an external device. The computer program instructions may arrive at the terminal device 200 via an electromagnetic carrier signal or be copied from a physical entity such as a computer program product, a memory device or a record medium such as a Compact Disc (CD), a Compact Disc Read-Only Memory (CD-ROM), a Digital Versatile Disk (DVD) or a Blu-ray disk.

According to an example embodiment, the terminal device 200 comprises at least one apparatus 230. The apparatus 230 may comprise, for example, a chip or a chipset, an electronic device or a module comprising circuitry for performing functions described below. In the example of FIG. 2, the apparatus 230 comprises a radio frequency (RF) module. According to an example embodiment, the apparatus 230 comprises a radio frequency front end module. The radio frequency front end module comprises circuitry configured to receive and/or transmit wireless signals.

According to an example embodiment, the apparatus 230 is configured to operate on a predefined frequency band. According to an example embodiment, the apparatus 230 is configured to operate on a frequency band higher than 52.6 GHz, For example the apparatus 230 may be configured to operate on a 64-71 GHz frequency range.

According to an example embodiment, the apparatus 230 comprises at least one power integrator. According to an example embodiment, a power integrator is associated with a radio beam direction. A power integrator may be associated with a radio beam direction via one or more phase shifters each of which associated with an antenna element. A power integrator is an element whose output signal is the time integral of its input signal. In other words, a power integrator accumulates the input quantity over a predetermined period of time in order to produce a representative output. A power integrator may be a hardware implementation, a software implementation or a combination thereof. In the examples below, the power integrator 407 is a hardware implementation.

According to an example embodiment, the apparatus 230 comprises a power integrator associated with a beam direction. A beam direction may correspond to an entry in a beam codebook. A power integrator associated with a beam direction enables accumulating the measure of power level of a radio beam in a particular direction over a predetermined period of time. According to another example embodiment, the apparatus 230 comprises a plurality of power integrators such that each of the plurality of power integrators is associated with a beam direction.

According to an example embodiment, the at least one power integrator comprises a single power integrator associated with a beam direction. According to another example embodiment, the at least one power integrator comprises a plurality of power integrators, wherein each of the plurality of power integrators is associated with a beam direction.

According to an example embodiment, the apparatus 230 is configured to receive a measure of power level of at least one radio beam detected by an antenna array comprising a plurality of antenna elements. According to an example embodiment, the measure of power level comprises a power level of a single beam detected by a single antenna element. The measure of power level of at least one radio beam may comprise a filtered measure of power level of the at least one radio beam.

According to an example embodiment, the measure of power level comprises a combined signal comprising individual power measurements from the plurality of antenna elements. As the antenna array comprises a plurality of antenna elements, power levels of each of the plurality of antenna elements may be measured concurrently.

According to an example embodiment, a measure of power level comprises a received signal strength indicator. For example, the measure of power level may be indicated, for example, by received signal strength indicator (RSSI) of 3GPP specifications.

According to an example embodiment, the apparatus 230 is configured to accumulate the received measure of power level over a period of time. According to an example embodiment, the period of time comprises an SSB period. The SSB period may be, for example, 20 milliseconds. For example, the apparatus 230 may be configured to accumulate the received measure of power level over a period of 20 milliseconds for each antenna element. As another example, the apparatus 230 may be configured to accumulate the received measure of power level over a period of 5, 10, 25 or any other suitable period of time.

According to an example embodiment, the apparatus 230 is further configured to determine a representative output signal corresponding to the accumulated measure of received power level.

According to an example embodiment, the apparatus 230 is further configured to provide the representative output signal to a controller. According to an example embodiment, the controller is configured to identify a radio frequency beam with the highest power among a plurality of radio frequency beams. According to an example embodiment, the controller comprises a comparator configured to analyse the representative output signal and determine which antenna element has the highest measure of power level. According to an example embodiment, the controller is comprised by the apparatus 230.

The power integrator enables performing initial power sweep in the RF front end without powering on any other parts of an RF chain such as a transceiver and/or a baseband unit.

Without limiting the scope of the claims, an advantage of an apparatus such as an RF front end module comprising a power integrator is that the RF front end module can perform an initial beam search or simple beam tracking without enabling the baseband unit or RF transceiver. Therefore, the power integrator enables analogue beam tracking with lower current consumption of a terminal device. Another advantage is that the RF front end module can operate independently from the state of the terminal device. A further advantage of an RF front end module comprising a power integrator is that multiple antenna elements may be measured in concurrently, which makes beam acquisition faster.

According to an example embodiment, the apparatus 230 further comprises at least one phase shifter. A phase shifter is configured to enable shaping and/or steering transmission and/or reception of beams towards a desired direction. A phase shifter may be associated with an antenna element via a low-noise amplifier (LNA).

According to an example embodiment, the apparatus 230 comprises at least one phase shifter associated with at least one antenna element. For example, a single phase shifter may be associated with a single antenna element or a plurality of phase shifters may be associated with a single antenna element. A plurality of phase shifters associated with a single antenna element enables measuring a power level of a plurality of beams concurrently.

According to an example embodiment, the at least one phase shifter comprises a single phase shifter associated with a single antenna element. According to another example embodiment, the apparatus 230 comprises a plurality of phase shifters associated with a single antenna element. According to an example embodiment, the apparatus 230 comprises a plurality of phase shifters, wherein each of the plurality of phase shifters is associated with a single antenna element.

Without limiting the scope of the claims, an advantage of an apparatus such as an RF front end module comprising a plurality of phase shifters associated with a single antenna element is that a plurality of radio beams can be measured concurrently.

According to an example embodiment, the apparatus 230 comprising at least one power integrator, the apparatus 230 comprises means for receiving a measure of power level of at least one radio beam detected by an antenna array comprising a plurality of antenna elements, means for accumulating the received measure of power level over a period of time, means for determining a representative output signal corresponding to the accumulated measure of received power level, and means for providing the representative output signal to a controller. According to an example embodiment, the controller comprises means for identifying a radio frequency beam with the highest power among a plurality of radio frequency beams.

The example embodiments may be implemented in a system comprising at least one power integrator, the system comprising: means for receiving a measure of power level of at least one radio beam detected by an antenna array comprising a plurality of antenna elements, means for accumulating the received measure of power level over a period of time, means for determining a representative output signal corresponding to the accumulated measure of received power level and means for providing the representative output signal to the at least one controller.

According to an example embodiment, the system comprises at least one power integrator, the system being configured to: receive a measure of power level of at least one radio beam detected by an antenna array comprising a plurality of antenna elements, accumulate the received measure of power level over a period of time, determine a representative output signal corresponding to the accumulated measure of received power level and provide the representative output signal to a controller.

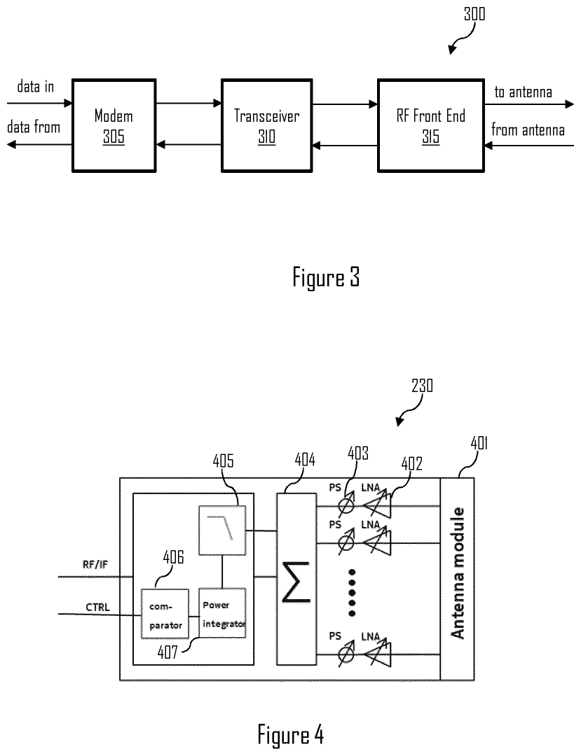

FIG. 3 illustrates a signal path 300 for RF signals in a terminal device or a base station. The signal path 300 in the example of FIG. 3 illustrates a signal path from an antenna array comprising a plurality of antenna elements to a modem 305 and from the modem 305 to the antenna array comprising a plurality of antenna elements. The signal path 300 comprises a baseband part and an RF part. The baseband part comprises the modem 305 comprising a chip configured to allow, for example, a terminal device to connect to cellular networks. The modem 305 may further be configured to convert digital data into RF signals for transmission and received RF signals back to digital data.

The RF part comprises an RF transceiver 310 for transmitting and receiving radio signals and an RF front end (RFFE) 315 for enabling operation of a device with a specific radio frequency. An RF transceiver 310 comprises a radio transmitter and a radio receiver. An RFFE 315 is located between an antenna and a baseband. An RFFE may comprise one or more filters, low-noise amplifiers (LNAs) and down-conversion mixers for processing modulated signals received at the antenna into signals suitable for input into the baseband analogue-to-digital converter (ADC).

FIG. 4 is a block diagram depicting an apparatus 230 operating in accordance with an example embodiment of the invention. In the example of FIG. 4, the apparatus is a radio frequency front-end module (RFFE). According to an example embodiment, the apparatus 230 is an RFFE receiver comprised by a terminal device such as a mobile computing device.

According to an example embodiment, the apparatus 230 comprises an antenna module 401. The antenna module 401 comprises an antenna array comprising a plurality of antenna elements. For example, the antenna module 401 may comprise 2, 4, 6, 8 or 10 antenna elements. An antenna module may also comprise more than 10 antenna elements, for example, 64 antenna elements.

The apparatus 230 further comprises a plurality of low-noise amplifiers (LNAs) 402 and a plurality of phase shifters (PSs) 403. In the example of FIG. 4, a single LNA 402 and a single PS 403 is associated with a single antenna element. Therefore, in the example of FIG. 4, a single antenna element is configured to receive a single beam. For example, assuming the apparatus 230 comprises an antenna module 401 comprising four antenna elements, the apparatus 230 comprises four LNAs 402 and four PSs 403.

In the example of FIG. 4, the apparatus 230 further comprises an adding mechanism 404 configured to add signals from the plurality of phase shifters 403 in order to form a combined signal representing a beam direction. A beam direction may correspond to an entry in a beam codebook. The adding mechanism 404 is further configured to feed the combined signal to a tuneable filter 405.

The apparatus 230 further comprises at least one power integrator 407. The power integrator 407 is configured to receive a measure of power level of a radio beam detected by a single antenna element and accumulate the received measure over a period of time. As a single phase shifter and a single low-noise amplifiers is associated with a single antenna element, a power level of each antenna element may be measured independently thereby enabling receiving measurements from a plurality of antenna elements concurrently.

The apparatus 230 is further configured to determine a representative output signal corresponding to the accumulated measure of received power level and provide the representative output signal to a controller. In the example of FIG. 4, the controller is a comparator 406 configured to analyse the representative output signal and thereby identify a radio beam with the highest power. The comparator 407 may comprise, for example, a microprocessor comprising an audio-digital converter (ADC).

FIG. 5 is a block diagram depicting an apparatus 230 operating in accordance with another example embodiment of the invention. In the example of FIG. 5, the apparatus is a radio frequency front-end module (RFFE). According to an example embodiment, the apparatus 230 is an RFFE receiver comprised by a terminal device such as a mobile computing device.

According to an example embodiment, the apparatus 230 comprises an antenna module 501. The antenna module 501 comprises an antenna array comprising a plurality of antenna elements. For example, the antenna module 501 may comprise 2, 4, 6, 8 or 10 antenna elements. An antenna module may also comprise more than 10 antenna elements, for example, 64 antenna elements.

The apparatus 230 further comprises a plurality of low-noise amplifiers (LNAs) 502 and a plurality of phase shifters (PSs) 503. In the example of FIG. 5, a plurality of phase shifters 503 are associated with a single antenna element via a single LNA 502. Therefore, as a plurality of phase shifters enable performing a power sweep in a plurality of directions, in the example of FIG. 5, a single antenna element is configured to receive a plurality of beams.

The apparatus 230 further comprises an adding mechanism 504 configured to add signals from the plurality of phase shifters 503 in order to form a combined signal. The adding mechanism 504 is further configured to feed the combined signal to a tuneable filter 505.

The apparatus 230 in the example of FIG. 5 further comprises a plurality of power integrators 507. Each power integrator 507 is configured to receive a measure of power level of radio beams detected by a plurality of antenna elements and accumulate the received measures over a period of time.

The apparatus 230 is further configured to determine a representative output signal corresponding to the accumulated measure of received power level and provide the representative output signal to a controller. In the example of FIG. 5, the controller is a control logic 506 configured to analyse the representative output signal and select a radio beam with the highest power using the switch 508.

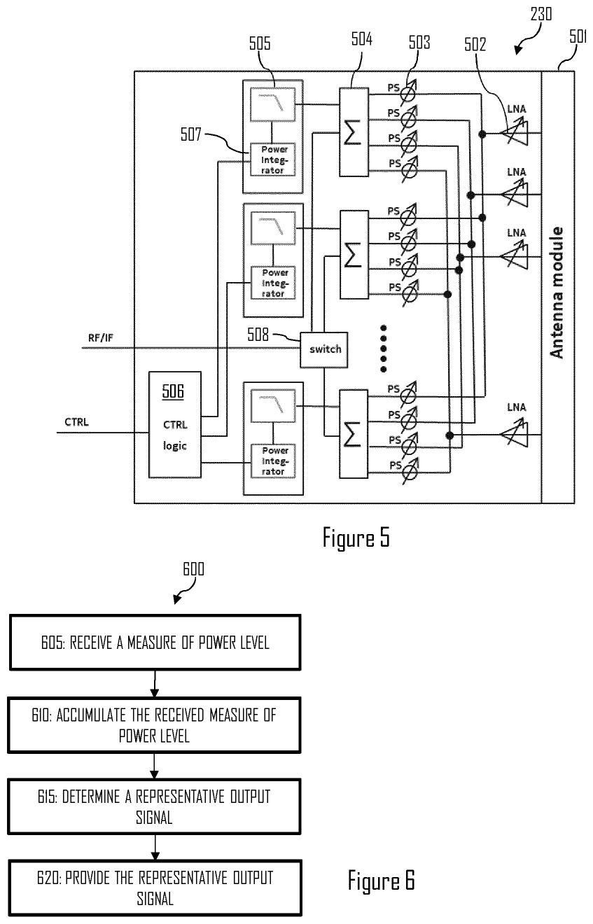

FIG. 6 illustrates a method 600 incorporating aspects of the previously disclosed embodiments. More specifically, the example method 600 illustrates a method performed by the apparatus 230 comprising at least one power integrator. The apparatus 230 may be comprised by a terminal device such as user equipment.

The method starts with receiving 605 a measure of power level of at least one radio beam detected by an antenna array comprising a plurality of antenna elements.

The method continues with accumulating 610 the received measure of power level over a period of time. The period of time may comprise, for example, an SSB period such as 20 milliseconds.

The method further continues with determining 615 a representative output signal corresponding to the accumulated measure of received power level and providing 620 the representative output signal to a controller.

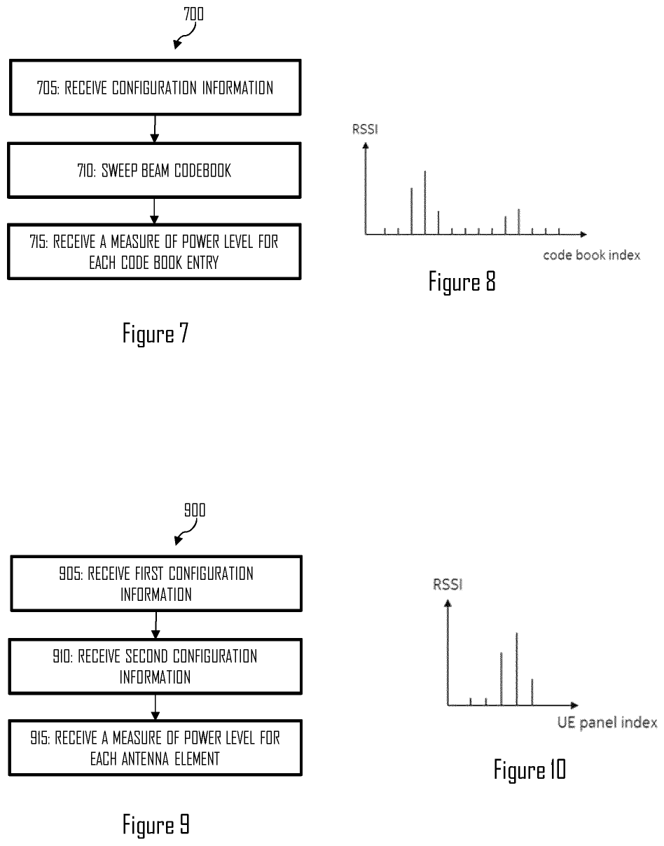

FIG. 7 illustrates a method 700 incorporating aspects of the previously disclosed embodiments. More specifically, the example method 700 illustrates a method for performing beam scanning of a single antenna element. In the example of FIG. 7, the method is performed by the apparatus 230 comprising at least one power integrator. The apparatus 230 may be comprised by a terminal device such as user equipment.

The method begins with receiving 705 configuration information. The configuration information may be received from the RF chain the RF front end belongs to, for example, from a baseband unit or a transceiver. The configuration information comprises a beam codebook comprising a set of analogue phase shift values and/or magnitude values to be applied to antenna elements in order to form an analogue beam. In this example, forming an analogue beam comprises tuning an antenna element in a particular direction based on the beam codebook.

The method continues with sweeping 710 the beam codebook. Sweeping the beam codebook comprises tuning an antenna element to different directions based on the codebook comprising magnitude and phase weights for an antenna element. For example, assuming the beam codebook comprises 14 entries corresponding to 14 different beam patterns, sweeping the beam book comprises tuning the antenna element to 14 different directions according to the beam codebook entries. Sweeping the beam codebook further comprises measuring a power level of each beam pattern. A power level may comprise, for example, a received signal strength indicator (RSSI).

The method further continues with receiving 715 a measure of power level for each codebook entry. In other words, the apparatus 230 receives a corresponding measure of power level for each entry in the beam codebook. Based on the received measures of power, the terminal device may schedule SSB decoding on the antenna elements with highest measures of power level.

FIG. 8 illustrates example measures of power level. In the example of FIG. 8, the beam codebook comprises 14 entries for which 14 corresponding measures of power level are measured. The measure of power level comprises a received signal strength indicator (RSSI). In FIG. 8, the beam corresponding to the 4th beam codebook entry has the highest received signal strength indicator.

FIG. 9 illustrates a method 900 incorporating aspects of the previously disclosed embodiments. More specifically, the example method 900 illustrates a method for performing beam scanning of a plurality of antenna elements. In the example of FIG. 9, the method is performed by the apparatus 230 comprising at least one power integrator. The apparatus 230 may be comprised by a terminal device such as user equipment.

The method begins with receiving 905 first configuration information. The first configuration information comprises SSB modulation information relating to a first antenna element. The first antenna element may be, for example, a primary antenna element.

The method continues with receiving 910 second configuration information. The second configuration information comprises an instruction to measure power level of each antenna element.

The method further continues with receiving 915 a measure of power level for each antenna element.

Based on the received measures of power, the terminal device may select the antenna element with the highest measure of power level for primary operation.

FIG. 10 illustrates example measures of power level. In the example of FIG. 10, a terminal device comprises five antenna elements for which corresponding measures of power level are measured. The measure of power level comprises a received signal strength indicator (RSSI). In FIG. 10, the fourth antenna element has the highest received signal strength indicator.

Without limiting the scope of the claims, an advantage of a power integrator comprised by a RF front end module is that power levels of a plurality of antenna elements may be measured concurrently without activating a transceiver. An advantage of a plurality of phase shifters associated with a single antenna element is that power levels of a plurality of radio beams may be measured concurrently. A further advantage is that the circuitry according to the example embodiments is small and thereby requires less hardware than, for example, multiplying hardware for concurrently measuring power levels of a plurality of antenna elements and/or radio beams.

Without in any way limiting the scope, interpretation, or application of the claims appearing below, a technical effect of one or more of the example embodiments disclosed herein is that power consumption may be reduced. Another technical effect of one or more example embodiments is that time needed for acquiring the most suitable antenna element and radio beam may be reduced as power measurements provided by the apparatus enable quickly narrowing down the candidates for the most suitable antenna element and radio beam.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments of the present invention may be implemented in software, hardware, application logic or a combination of software, hardware and application logic. The software, application logic and/or hardware may reside on the apparatus, a separate device or a plurality of devices. If desired, part of the software, application logic and/or hardware may reside on the apparatus, part of the software, application logic and/or hardware may reside on a separate device, and part of the software, application logic and/or hardware may reside on a plurality of devices. In an example embodiment, the application logic, software or an instruction set is maintained on any one of various conventional computer-readable media. In the context of this document, a ‘computer-readable medium’ may be any media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It will be obvious to a person skilled in the art that, as the technology advances, the inventive concept can be implemented in various ways. The invention and its embodiments are not limited to the examples described above but may vary within the scope of the claims.

1. An apparatus comprising at least one power integrator, the apparatus being configured to:
receive a measure of power level of at least one radio beam detected by an antenna array comprising a plurality of antenna elements;
accumulate the received measure of power level over a period of time;
determine a representative output signal corresponding to the accumulated measure of received power level; and
provide the representative output signal to a controller.

2. The apparatus according to claim 1, wherein the apparatus further comprises at least one phase shifter associated with at least one antenna element.

3. The apparatus according to claim 1, wherein the at least one power integrator comprises a single power integrator associated with a beam direction.

4. The apparatus according to claim 2, wherein the at least one phase shifter comprises a single phase shifter associated with a single antenna element.

5. The apparatus according to claim 1, wherein the at least one power integrator comprises a plurality of power integrators, wherein each of the plurality of power integrators is associated with a beam direction.

6. The apparatus according to claim 2, wherein the at least one phase shifter comprises a plurality of phase shifters, wherein each of the plurality of phase shifters is associated with a single antenna element.

7. The apparatus according to claim 1, wherein a measure of power level comprises a combined signal comprising individual power measurements from the plurality of antenna elements.

8. The apparatus according to claim 1, wherein the measure of power level comprises a received signal strength indicator.

9. The apparatus according to claim 1, wherein the controller is configured to identify a radio frequency beam with the highest power among a plurality of radio frequency beams.

10. The apparatus according to claim 1, wherein the controller is comprised by the apparatus.

11. The apparatus according to claim 1, wherein the apparatus is configured to operate on a frequency band higher than 52.6 GHz.

12. The apparatus according to claim 1, wherein the apparatus comprises a radio frequency front end module.

13. A method performed by an apparatus comprising at least one power integrator, the method comprising:
receiving a measure of power level of at least one radio beam detected by an antenna array comprising a plurality of antenna elements;
accumulating the received measure of power level over a period of time;
determining a representative output signal corresponding to the accumulated measure of received power level; and
providing the representative output signal to a controller.

14. (canceled)

15. A system comprising at least one power integrator, the system being configured to:
receive a measure of power level of at least one radio beam detected by an antenna array comprising a plurality of antenna elements;
accumulate the received measure of power level over a period of time;
determine a representative output signal corresponding to the accumulated measure of received power level; and
provide the representative output signal to a controller.

16. (canceled)

17. A non-transitory computer readable medium comprising instructions for causing an apparatus comprising at least one power integrator to perform at least the following:
receiving a measure of power level of at least one radio beam detected by an antenna array comprising a plurality of antenna elements;
accumulating the received measure of power level over a period of time;
determining a representative output signal corresponding to the accumulated measure of received power level; and
providing the representative output signal to a controller.

18. The system according to claim 15, wherein the system further comprises at least one phase shifter associated with at least one antenna element.

19. The system according to claim 18, wherein the at least one phase shifter comprises a single phase shifter associated with a single antenna element.

20. The system according to claim 18, wherein the at least one phase shifter comprises a plurality of phase shifters, wherein each of the plurality of phase shifters is associated with a single antenna element.

21. The system according to claim 15, wherein the at least one power integrator comprises a single power integrator associated with a beam direction.

22. The system according to claim 15, wherein the at least one power integrator comprises a plurality of power integrators, wherein each of the plurality of power integrators is associated with a beam direction.
